(19) United States
(12) Patent Application Publication
(10) Pub. No.: US 2016/0211926 A1
(43) Pub. Date: Jul. 21, 2016

(54) WIRELESS COMMUNICATION METHOD FOR AVOIDING NOISE INTERFERENCE WITH MULTIPLE FREQUENCY BAND

(71) Applicant: Hakseo OH, Gyeonggi-do (KR)

(72) Inventors: Hakseo OH, Gyeonggi-do (KR); Hyosuk PARK, Gyeonggi-do (KR); Sangkyo AHN, Gyeonggi-do (KR); Jinhwan KO, Seoul (KR); Sunghyuk YOUN, Incheon (KR); Youlkwon SUNG, Gyeonggi-do (KR)

(21) Appl. No.: 15/001,939

(22) Filed: Jan. 20, 2016

(30) Foreign Application Priority Data
Jan. 20, 2015 (KR) 10-2015-0009027

(51) Int. Cl. H04B 15/00; H04B 17/345

(52) U.S. Cl. CPC H04B 15/00; H04B 17/345

(57) ABSTRACT

A wireless communication method comprises steps of: trying a communication through a RF communication module by means of a control module in the communication unit for unmanned automatic transfer device; detecting a frequency band having a noise interference by means of the control module; avoiding the noise interference according to the detection result thereof by means of the control module; and carrying out a normal communication between the communication unit for unmanned automatic transfer device and the communication unit for equipment.

### CROSS REFERENCE

This application claims foreign priority under Paris Convention to Korean Patent Application No. 10-2015-0009027, filed 20 Jan. 2015, with the Korean Intellectual Property Office.

### BACKGROUND

The present invention relates to a wireless communication method for avoiding a noise interference with a multiple frequency band, and more particularly, to a wireless communication method for avoiding a noise interference with a multiple frequency band in that it can avoid a communication interference owing to various noises through two or more communication modules of different available frequency bands or communication modes in a communication between a communication unit for unmanned automatic transfer device and a communication unit for equipment, thereby constituting a normal wireless communication link.

Generally, in manufacturing processes of a liquid crystal display device and a semiconductor element, the manufacturing goods are transferred to the manufacturing stations of each manufacturing process by using an automated material handling system (AMHS), so that the corresponding goods are manufactured according to the manufacturing processes of each manufacturing station. Such an automated material handling system utilizes an unmanned automatic transfer device for transferring a carrier of receiving a semiconductor substrate or a liquid crystal substrate to the manufacturing station located on the manufacturing process line and transferring the carrier of again receiving the goods completely processed in the corresponding manufacturing station to the next manufacturing station.

Depending on the movement method thereof, the unmanned automatic transfer device includes an automated guided vehicle (AGV) for driving through the wheel, a rail guided vehicle (RGV) for driving along the guide rail located at the bottom, and an overhead hoist transport (OHT) for driving a guide rail installed in the ceiling. These unmanned automatic transfer devices are moved to the corresponding manufacturing equipment by using the wheel itself or along the bottom rail or the overhead rail and it carries the carrier onto or carries the carrier out the manufacturing equipment by using an operating arm or a hoist and a hand.

The carrying/carrying out of the carriers is accomplished by the host computers mounted on the unmanned automatic transfer device and the manufacturing equipments under the control of the main controller for controlling the entire manufacturing lines. At this time, since it requires the interlock operation between the unmanned automatic transfer device and the manufacturing equipment during the carrying/carrying out of the carrier, transmission devices of an optical communication mode using an IR (Infrared) are installed on the unmanned automatic transfer device and the manufacturing equipment respectively so as to send and receives the necessary data, thereby smoothly performing the carrying/carrying out of the carriers.

FIG. 1a is a schematic diagram illustrating a communication between an unmanned automatic transfer device and a manufacturing equipment in a communication system for automated material handling system of the conventional IR optical communication. In the practice of the communication using this way, there is a disadvantage in that communication units between an unmanned automatic transfer device and a manufacturing equipment should be installed in close proximity as possible. Accordingly, in order to communicate with the unmanned automatic transfer device installed on the ceiling using the IR optical communication, the communication unit of the manufacturing equipment must be installed on the ceiling in like manner.

Owing to this installation constraint, the cable of the communication unit for equipment should be lengthily installed along the ceiling having above 5 m height. Also, it has difficulty in the beauty and management inside the plant. Moreover, since it send and receive the communication without the generation of a unique ID, the communication interference between adjacent communication devices can be generated due to the optical noise. Also, the optical noises can be generated owing to various devices such as a fluorescent lamp, an optical sensor, a laser sensor, a remote control, a hand terminal etc. as well as the communication device, thus it can be expected to cause the malfunction.

Where it replaces the IR optical communication module with the RF (Radio-Frequency) communication module so as to overcome the above drawbacks, since the data is transmitted through the ID, it can avoid the problem of the interference. Also, although the communication unit for equipment is not installed on the ceiling, the communication between the unmanned automatic transfer device and the manufacturing equipment can be made. When the IR mode and the RF mode are used respectively, the difference in install structure of the communication unit between the unmanned automatic transfer device and the manufacturing equipment can be easily examined with reference to FIG. 1b.

On the other hand, in spite of the above advantage, even if it replaces the IR optical communication module with the RF communication module as shown in FIG. 2, there are still many problems. The frequency band, which is usually used in the RF communication of the process line, is an ISM band (Industrial Scientific Medical band) and the ISM band is the frequency band capable of utilizing in an industry device, a science device, and a medical device without a separate permit from the government. Presently, the common ISM band is set to 2.4 GHz band and 5.7 GHz band in Korea.

Since the user can use the ISM band free of charge without the separate frequency license from the government, there can be interference from various peripheral devices using a WLAN, a ZigBee, and a Bluetooth. Also, where it radiate electromagnetic waves from components used in the semiconductor equipment, since the frequencies are not the same for each manufacturer, it is difficult to set the main communication frequency band so as to avoid the communication interference.

Prior Art Patent Literature: Korean Patent Registration No. 0292029 (Registration date: Mar. 19, 2001)

### SUMMARY OF THE INVENTION

The invention has been made in consideration of the circumstances described above, and a technical object of the present invention is to provide a wireless communication method for avoiding a noise interference with a multiple frequency band in that it can avoid a communication interference owing to various noises through two or more communication modules of different available frequency bands or communication modes in a communication between a communication unit for unmanned automatic transfer device and a communication unit for equipment, thereby constituting a normal wireless communication link.

Another object of the present invention is to provide a wireless communication method for avoiding a noise interference with a multiple frequency band in that it detects a frequency band having the peripheral current noise frequency band by means of the control module of the communication unit so as to analyze a position, a width, an intensity and a persistence of the band etc. and selects the most effective method in accordance with the analyzed current condition, thereby avoiding the communication interference owing to the noise.

According to an aspect of the invention to achieve the object described above, there is provided a wireless communication method for avoiding a noise interference with a multiple frequency band and carrying out a wireless communication between a communication unit for unmanned automatic transfer device and a communication unit for equipment having two or more communication modules of different available frequency bands or communication modes in an environment having a noise interference including steps of: trying a communication through a RF communication module by means of a control module in the communication unit for unmanned automatic transfer device; detecting a frequency band having a noise interference by means of the control module; avoiding the noise interference according to the detection result thereof by means of the control module; and carrying out a normal communication between the communication unit for unmanned automatic transfer device and the communication unit for equipment.

Preferably, a communication means is changed to a RF communication module having another available frequency band in the step of avoiding the noise interference according to the detection result thereof by means of the control module, where the available frequency band of trying a communication is included in the noise frequency band detected from the step of detecting the frequency band having the noise interference by means of the control module.

Preferably, a communication means is changed to a RF communication module having another communication mode in the step of avoiding the noise interference according to the detection result thereof by means of the control module, where two or more available frequency bands are included in the noise frequency band detected from the step of detecting the frequency band having the noise interference by means of the control module.

Preferably, the RF communication module having another communication mode is an IR optical communication module.

Preferably, it is changed to an interference-free frequency within the available frequency band of trying a communication in the step of avoiding the noise interference according to the detection result thereof by means of the control module, where the noise frequency band detected from the step of detecting the frequency band having the noise interference by means of the control module is narrower than a certain standard.

Preferably, it communicates at the same time through two or more frequencies within the available frequency band of trying a communication in the step of avoiding the noise interference according to the detection result thereof by means of the control module, where the noise frequency band detected from the step of detecting the frequency band having the noise interference by means of the control module is narrower than a certain standard.

Preferably, it retries a transmission of a communication signal several times within a predetermined time in the step of avoiding the noise interference according to the detection result thereof by means of the control module, where the noise interference is discontinuously detected in the step of detecting the frequency band having the noise interference by means of the control module.

Preferably, it stops the retry thereof when the response signal on the corresponding communication signal reaches from the communication unit for equipment and it repeats the retry at an interval of time if there is no response.

Preferably, it performs a step of detecting a noise signal intensity prior to the step of avoiding the noise interference according to the detection result thereof by means of the control module and amplifies an output by larger communication signal intensity than the noise signal intensity detected in the step of avoiding the noise interference according to the detection result thereof by means of the control module.

Preferably, the amplified power intensity information is included in the data packet when the output intensity of the communication is amplified to be communicated, so that it responds by the same output intensity when the communication unit for equipment responds.

Preferably, the step of trying the communication through the RF communication module by means of a control module in the communication unit for unmanned automatic transfer device is performed after the step of avoiding the noise interference according to the detection result thereof by means of the control module.

### BRIEF DESCRIPTION OF THE DRAWINGS

The above and other objects, features and advantages of the present invention will be more apparent from the following detailed description taken in conjunction with the accompanying drawings, in which:

FIGS. 1a and 1b are schematic diagrams illustrating a difference in install structure of the communication unit between the unmanned automatic transfer device and the manufacturing equipment when a conventional IR mode and RF mode are used respectively;

FIG. 2 is a schematic block diagram illustrating a wireless communication unit in a RF communication system for conventional automated material handling system;

FIG. 3 is a schematic block diagram illustrating a wireless communication unit of a wireless communication system for automated material handling system according to one embodiment of the present invention;

FIG. 4 is a flow chart illustrating a wireless communication method for avoiding a noise interference with a multiple frequency band according to one embodiment of the present invention;

FIG. 5 is a schematic drawing illustrating a communication operation of changing the communication frequency to an interference-free frequency within the available frequency band of trying a communication according to one embodiment of the present invention; and

FIG. 6 is an oscilloscope waveform of measuring a signal output in accordance with the existence of response signals when it retries a transmission of a communication signal several times within a predetermined time according to one embodiment of the present invention.

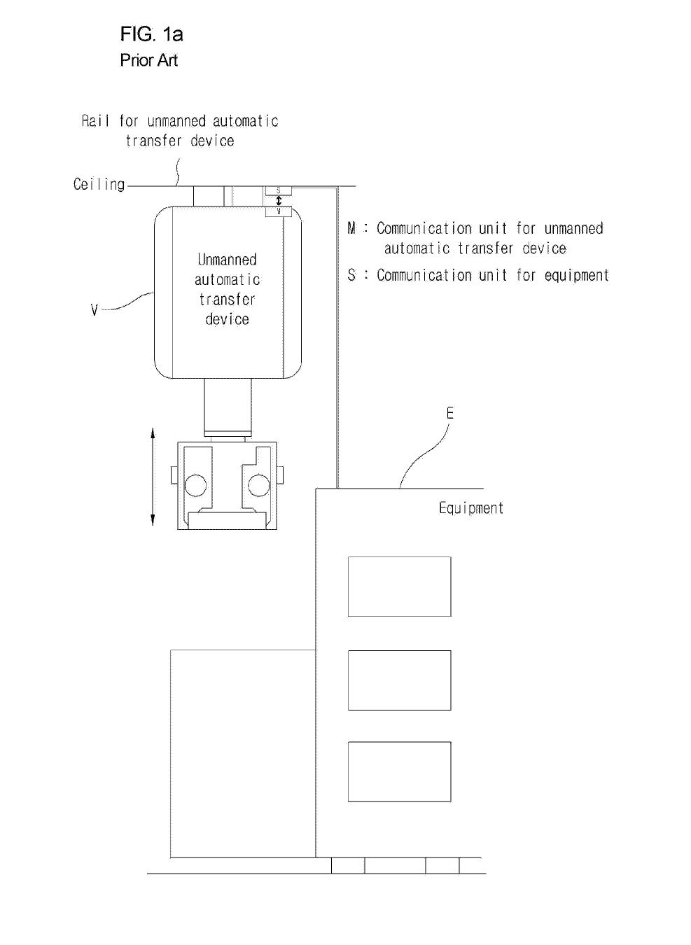

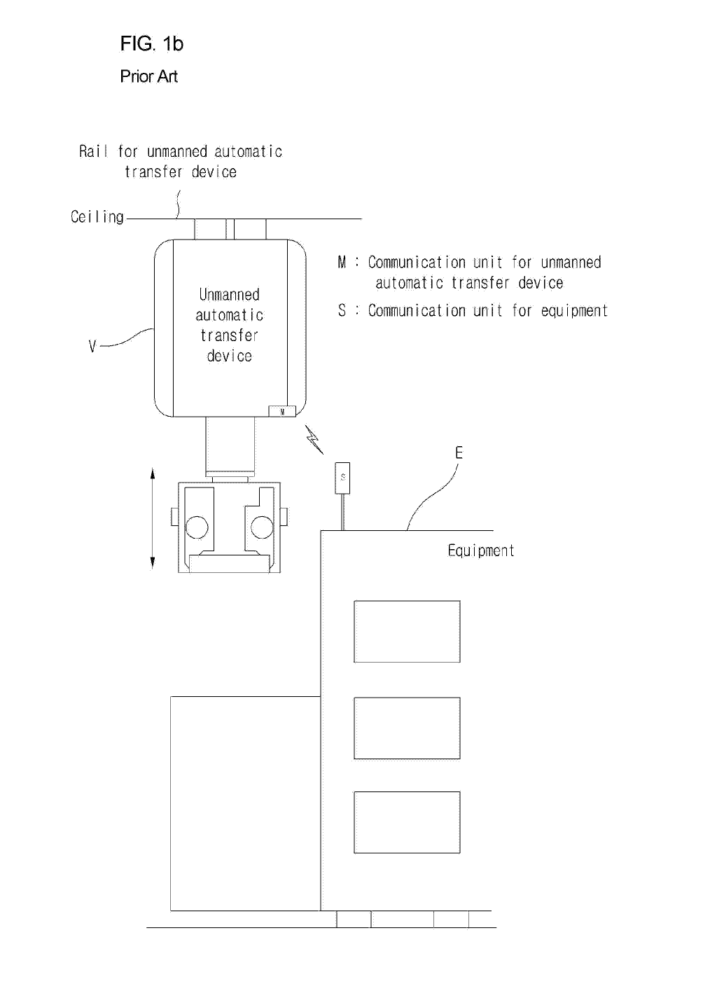

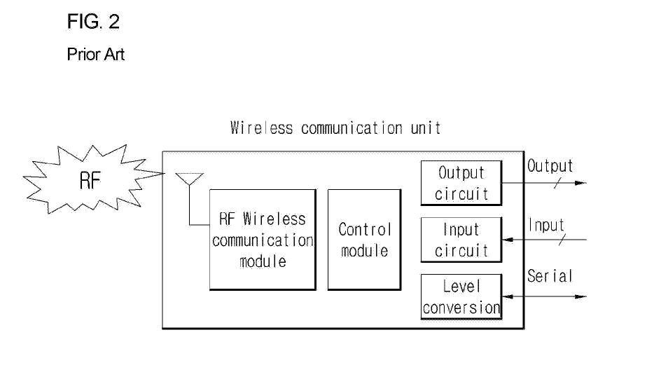

### DETAILED DESCRIPTION OF THE PREFERRED EMBODIMENT

Hereinafter, a preferred embodiment of the invention will be described in detail with reference to the accompanying drawings. In the drawings, parts irrelevant to the description are omitted for a clear explanation of the present invention, and the same reference numeral is applied to the same parts throughout the specification. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

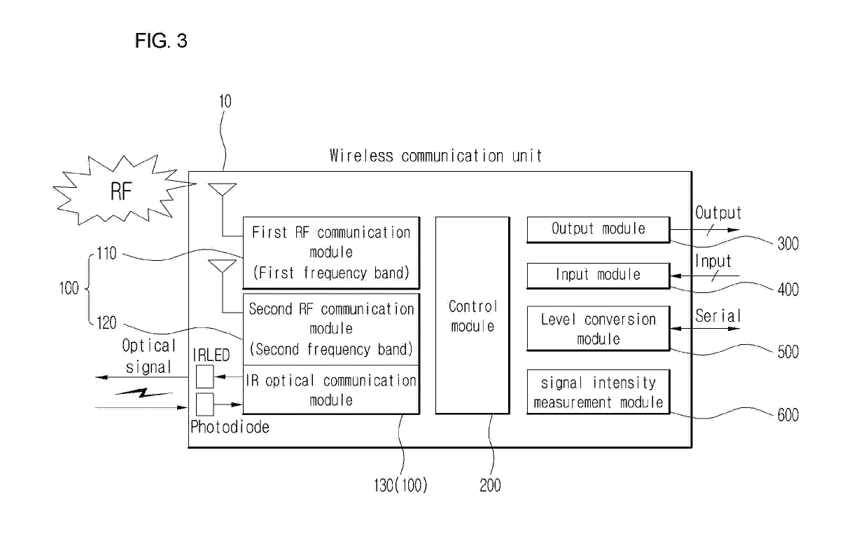

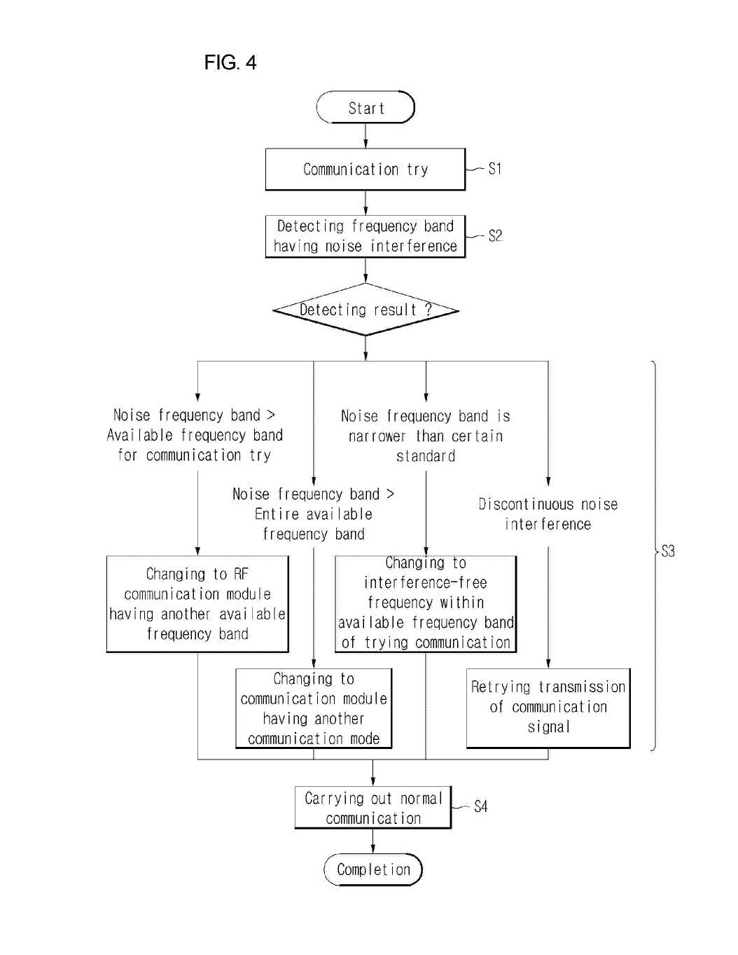

FIG. 3 is a schematic block diagram showing a wireless communication unit of a wireless communication system for automated material handling system according to one embodiment of the present invention and FIG. 4 is a flow chart showing a wireless communication method for avoiding a noise interference with a multiple frequency band according to one embodiment of the present invention.

Referring to FIG. 3 and FIG. 4, a wireless communication method for avoiding a noise interference with a multiple frequency band and carrying out a wireless communication between a communication unit for unmanned automatic transfer device (V) and a communication unit for equipment (E) having two or more communication modules of different available frequency bands or communication modes in an environment having a noise interference includes steps of (S1) trying a communication through a RF communication module 100 by means of a control module 200 in the communication unit 10 for unmanned automatic transfer device (V), (S2) detecting a frequency band having a noise interference by means of the control module 200, (S3) avoiding the noise interference according to the detection result thereof by means of the control module 200, and (S4) carrying out a normal communication between the communication unit 10 for unmanned automatic transfer device (V) and the communication unit 10 for equipment (E).

In the step S1 of trying a communication through the RF communication modules 110 and 120 by means of the control module 200 in the communication unit 10 for unmanned automatic transfer device (V), the control module 200 of the communication unit 10 for unmanned automatic transfer device (V) serves to generate a data packet over the RF communication module 110 and 120 and transmit it to the communication unit 10 for equipment (E).

A first RF communication module 110 of the communication unit 10 for unmanned automatic transfer device (V) includes input and output circuits for exchanging a signal with the control module 200 and a RF modulation and demodulation circuit, and a RF antenna. The control module 200 serves to transmit the generated command data packet to the manufacture equipment (E).

Also, it receives an identification information of the manufacture equipment (E) from the control module 200, sets the ID and channel information on the corresponding manufacture equipment, and initializes a communication chip. If the ID and channel information is written in the communications chip of the first RF communication module 110, the communication is available and then, the data can be transmitted toward the manufacture equipment (E).

The RF communication module 100 of the communication unit 10 for equipment (E) is the same as the first RF communication module 11 in structure thereof, so that the RF communication is made. It receives the command data from the RF communication module 100 of the communication unit 10 for unmanned automatic transfer device (V) and transmits a corresponding response signal thereto, so that the communication link between the communication unit 10 for unmanned automatic transfer device (V) and the communication unit 10 for equipment (E) is constituted. The control module 200 of the communication unit 10 for equipment (E) serves to analyze the data packet in the communication signal transmitted from the communication unit 10 for unmanned automatic transfer device (V), extract the identification information therefrom, and generate and transmit a response signal only when the extracted identification information is corresponded with the identification information of the equipment (E).

In the meantime, in the wireless communication system for automated material handling system according to one embodiment of the present invention, the communication unit 10 for unmanned automatic transfer device (V) and the communication unit 10 for equipment (E) should be provided with two or more communication modules of different available frequency bands or communication modes respectively.

That is, a second RF communication module 120 should be set to another available frequency band in addition to the first RF communication module 110. In this case, according to an ISM (Industrial Scientific Medical) band, the available frequency band of the first RF communication module 110 can be set to a first frequency band of 2.4 GHz and the available frequency band of the second RF communication module 120 can be set to a second frequency band of 5.7 GHz.

Also, it is necessary to add another wireless communication module 100 having a different wireless communication mode.

Here, it is most preferred that the communication module 100 of a different communication type is an IR optical communication module 130. At this time, it is possible to equip with all of the first RF communication module 110, the second RF communication module 120, and the IR optical communication module 130. The wireless communication module 100 of the communication unit 10 for unmanned automatic transfer device (V) should be corresponded to the wireless communication module 100 of the communication unit 10 for equipment (E).

Also, the communication unit 10 for unmanned automatic transfer device (V) and the communication unit 10 for equipment (E) include an output module 300 and an input module 400 for exchanging the signals with the external device and the signal module 300 and a level conversion module 500 having a serial connection function.

In the step (S2) of detecting the frequency band having the noise interference by means of the control module 200, the control module 200 of the communication unit 10 for unmanned automatic transfer device (V) serves to detect the noise frequency band of the current environment and analyze a position, a width, an intensity and a persistence of the band etc. Also, in the step of avoiding the noise interference according to the detection result thereof by means of the control module 200, it can avoid the communication interference caused by the noise by selecting the most effective method in accordance with the analyzed current condition. Moreover, in the step (S4) of carrying out the normal communication between the communication unit for unmanned automatic transfer device (V) and the communication unit for equipment (E), it successfully avoids the interference noise and then, performs the wireless communication.

### First Embodiment

In the first embodiment of the present invention, where the available frequency band of trying a communication is included in the noise frequency band detected from the step (S2) of detecting the frequency band having the noise interference by means of the control module 200, it can be changed to the RF communication module 100 having another available frequency band in the step (S3) of avoiding the noise interference according to the detection result thereof by means of the control module 200.

In the foregoing step S1, where the control module 200 of the communication unit 10 for unmanned automatic transfer device (V) tries the communication in the first frequency band through the first RF communication module 110, if it is analyzed that the first frequency band is included in the noise frequency band detected by the control module 200, it is hard to normally communicate through the corresponding available frequency band.

Since the device of using the same frequency within the first frequency band is currently existed or the RF noise emitted when the specific equipment (E) is operated in the process line is currently existed, the control module 200 of the communication unit 10 for unmanned automatic transfer device (V) can change the communication means to the second RF communication module 120 having the available frequency band set to a second frequency band.

Thus, since it can try the communication in an interference-free frequency band through the changed second RF communication module 120, it can carry out a normal communication between the communication unit 10 for unmanned automatic transfer device (V) and the communication unit 10 for equipment (E).

### Second Embodiment

In the second embodiment of the present invention, where two or more available frequency bands are included in the noise frequency band detected from the step (S2) of detecting the frequency band having the noise interference by means of the control module 200, it can be changed to the RF communication module 100 having another communication mode in the step (S3) of avoiding the noise interference according to the detection result thereof by means of the control module 200.

In the foregoing step S1, where the control module 200 of the communication unit 10 for unmanned automatic transfer device (V) tries the communication in the first frequency band through the first RF communication module 110, if it is analyzed that the first frequency band and the second frequency band are included in the noise frequency band detected by the control module 200, it is hard to normally communicate through the available frequency band of the RF communication modules 110 and 120.

Since the device of using the same frequency within the first and second frequency band is currently existed or the RF noise emitted, when the specific equipment (E) is operated in the process line, is widely existed, the control module 200 of the communication unit 10 for unmanned automatic transfer device (V) can change the communication means to another communication module other than the RF communication module.

Thus, since it can try the communication in a communication mode irrelevant to the noise interference of the frequency through the communication module of the changed mode, it can carry out a normal communication between the communication unit 10 for unmanned automatic transfer device (V) and the communication unit 10 for equipment (E).

At this time, the kind of another communication mode module can be varied. However, as described above, the IR optical communication module 130 is most efficient.

### Third Embodiment

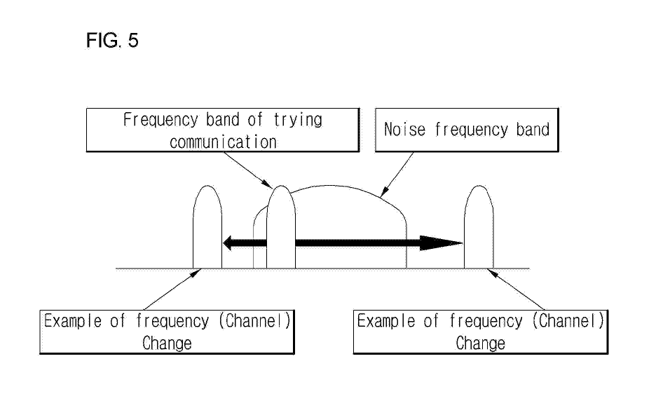

FIG. 5 is a schematic drawing illustrating a communication operation of changing the communication frequency to an interference-free frequency within the available frequency band of trying a communication according to one embodiment of the present invention.

Referring to FIG. 5, in the third embodiment of the present invention, where the noise frequency band detected from the step (S2) of detecting the frequency band having the noise interference by means of the control module 200 is narrower than a certain standard, it can be changed to an interference-free frequency within the available frequency band of trying a communication in the step (S3) of avoiding the noise interference according to the detection result thereof by means of the control module 200.

In the foregoing step S1, where the control module 200 of the communication unit 10 for unmanned automatic transfer device (V) tries the communication in the first frequency band through the first RF communication module 110, if it is analyzed that the noise frequency band detected by the control module 200 is partially included in or overlapped with the first frequency band, it is hard to normally communicate through the corresponding available frequency band.

However, because the noise band is narrow, it is unnecessary to replace the available frequency band or the communication mode so as to solve the problem. That is, as shown in FIG. 5, it changes the channel to the noise interference-free frequency within the first frequency band without the change of the communication module 100. The frequency is increased or decreased by a predetermined width within the available frequency band, so that it can avoid the noise interference.

Also, where the noise frequency band detected from the step (S2) of detecting the frequency band having the noise interference by means of the control module 200 is narrower than a certain standard, it is possible to communicate at the same time through two or more frequencies within the available frequency band of trying a communication in the step (S3) of avoiding the noise interference according to the detection result thereof by means of the control module 200.

That is, it can try the communication by simultaneously using a plurality of frequencies as the channel within the first frequency band from the beginning, without the use of only one frequency as the channel. Thus, although it establishes any frequency as the channel, the communication can be made. In addition, when the control module 200 generates a communication signal, an avoidance channel information is included in the data packets. Accordingly, where the communication is cut off during the normal communication, it is determined that the noise is introduced and then, it can try to communicate through the avoidance channel.

### Fourth Embodiment

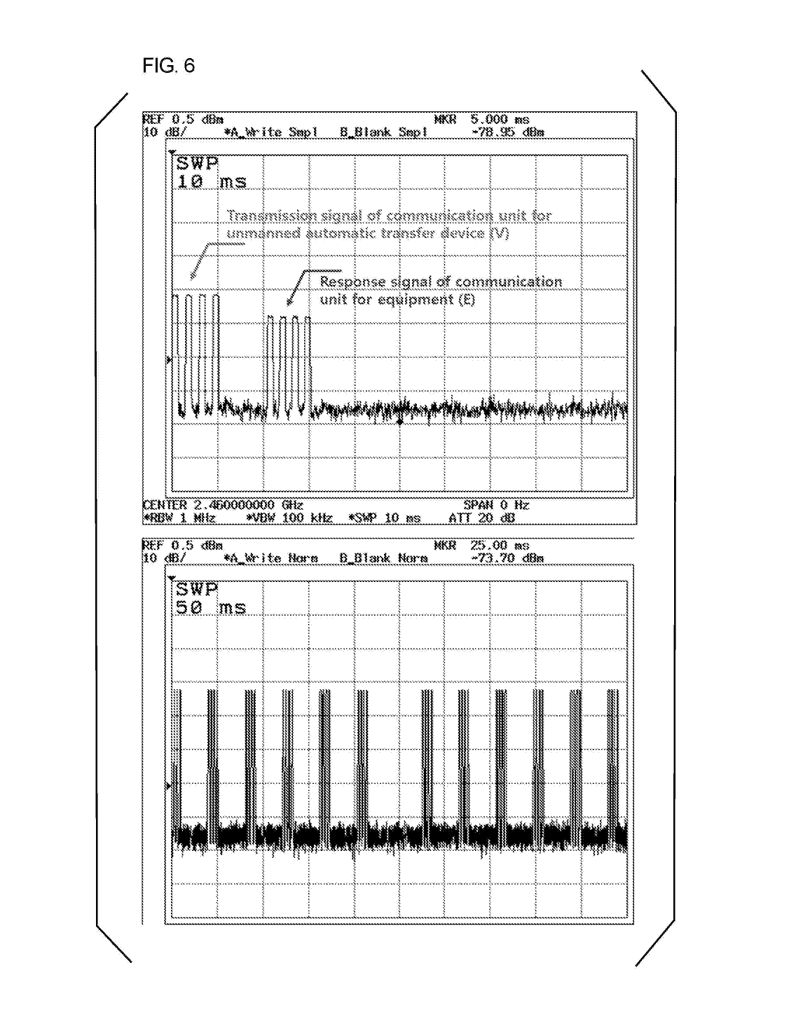

FIG. 6 is an oscilloscope waveform of measuring a signal output in accordance with the existence of response signals when it retries a transmission of a communication signal several times within a predetermined time according to one embodiment of the present invention.

Referring to FIG. 6, in the fourth embodiment of the present invention, where the noise interference is discontinuously detected in the step (S2) of detecting the frequency band having the noise interference by means of the control module 200, it can retry a transmission of a communication signal several times within a predetermined time in the step (S3) of avoiding the noise interference according to the detection result thereof by means of the control module 200.

In the foregoing step S1, where the control module 200 of the communication unit 10 for unmanned automatic transfer device (V) tries the communication in the first frequency band through the first RF communication module 110, if it is analyzed that the noise frequency band detected by the control module 200 is discontinuously detected, not continuously detected, it is hard to normally communicate through only a single communication attempt in the corresponding available frequency band.

Since the frequency is discontinuously generated, it is unnecessary to replace the available frequency band or the communication mode so as to solve the problem. That is, it can retry the transmission of the same communication signal several times within a predetermined time without the change of the communication module 100, so that the success rate of the communication can be increased.

Also, when the response signal on the corresponding communication signal reaches from the communication unit for equipment (E), it stops the retry thereof. Here, if there is no response, it is possible to repeat the retry at an interval of time. In FIG. 6, a top graph illustrates a case that the response signal on the corresponding communication signal reaches from the communication unit for equipment (E) and a bottom graph is an oscilloscope waveform of measuring an output of the transmission signal of the communication unit 10 for unmanned automatic transfer device (V) when it repeats the retry at an interval of time during non-response thereof.

In the embodiment of FIG. 6, it transmits four communication signals for 1 ms in the communication unit 10 for unmanned automatic transfer device (V), the response signal reaches from the communication module 100 of the communication unit for equipment (E) after a waiting time of about 1.5 ms, and then the retry thereof is stopped. If only one reception is made in the communication module 100 of the communication unit for equipment (E) from four transmissions thereof, it generates the response signal to be transmitted to the communication unit 10 for unmanned automatic transfer device (V).

However, if there is no response signal after a waiting time of about 2 ms over 1 ms, it again transmits four communication signals for 1 ms, and then, attempts a total of six retries for about 25 ms so as to wait for the response. If there is no response signal after the total of six retries, it can again repeat the retry at an interval of time. In the bottom graph of FIG. 6, it may look for such a signal output pattern easily. Thus, many transmissions are carried out in a shortest period till the normal response is mode, so that it can maximally increase the transmission success rate of the communication signal through the retry method.

### Fifth Embodiment

In the fifth embodiment of the present invention, it performs a step of detecting a noise signal intensity prior to the step (S3) of avoiding the noise interference according to the detection result thereof by means of the control module 200 and amplifies the output by larger communication signal intensity than the noise signal intensity detected in the step (S3) of avoiding the noise interference according to the detection result thereof by means of the control module 200.

In the foregoing step S1, where the control module 200 of the communication unit 10 for unmanned automatic transfer device (V) tries the communication in the first frequency band through the first RF communication module 110, if it is analyzed that the noise frequency band detected by the control module 200 is partially included in or overlapped with the first frequency band, after the intensity of the noise signal is measured through a signal intensity measurement module 600, it amplifies the output of the communication signal within the corresponding available frequency band so as to attempt the communication, without replacing the available frequency band or the communication mode so as to solve the problem.

In addition, when the control module 200 generates the communication signal, the amplified power intensity information is included in the data packet, so that it responds by the same output intensity even when the communication unit for equipment responds. Thus, since it can try the communication by amplifying the output by larger signal intensity than that of the peripheral noise without the change of the wireless communication module 100, it can carry out a normal communication between the communication unit 10 for unmanned automatic transfer device (V) and the communication unit 10 for equipment (E).

In the present invention including all of the above embodiments, the step (S1) of trying a communication through a RF communication module 100 by means of a control module 200 in the communication unit 10 for unmanned automatic transfer device (V) may be performed after the step (S3) of avoiding the noise interference according to the detection result thereof by means of the control module 200. Before the real try of the communication, the control module 200 detects the frequency band with the noise interference and determines the avoidance method according to the detected result so as to try to communicate.

According to the wireless communication method for avoiding the noise interference with the multiple frequency band of the present invention, it can avoid the communication interference owing to various noises through two or more communication modules of different available frequency bands or communication modes in the communication between the communication unit for unmanned automatic transfer device and the communication unit for equipment, so that the normal wireless communication link can be constituted, thereby ensuring a superior radio performance.

Also, it can detect a frequency band having the peripheral current noise frequency band by means of the control module of the communication unit so as to analyze the position, the width, the intensity and the persistence of the band etc. and select the most effective method in accordance with the analyzed current condition, thereby avoiding the communication interference owing to the noise. Accordingly, it is possible to maintain the normal communication in a variety of environmental noise and it can reduce the error processing cost and the time-consuming owing to the communication error.

Although embodiments of the present invention were described above, the spirit of the present invention is not limited thereto, changes and modifications substantially equivalent to the embodiment of the present invention should be construed as being included in the scope of the present invention, and the prevent invention may be changed in various ways within the scope of the present invention by those skilled in the art.

What is claimed is:

1. A wireless communication method for avoiding a noise interference with a multiple frequency band and carrying out a wireless communication between a communication unit for unmanned automatic transfer device and a communication unit for equipment having two or more communication modules of different available frequency bands or communication modes in an environment having a noise interference comprising steps of:
trying a communication through a RF communication module by means of a control module in the communication unit for unmanned automatic transfer device;
detecting a frequency band having a noise interference by means of the control module;
avoiding the noise interference according to the detection result thereof by means of the control module; and
carrying out a normal communication between the communication unit for unmanned automatic transfer device and the communication unit for equipment.

2. The method as claimed in claim 1, wherein a communication means is changed to a RF communication module having another available frequency band in the step of avoiding the noise interference according to the detection result thereof by means of the control module, where the available frequency band of trying a communication is included in the noise frequency band detected from the step of detecting the frequency band having the noise interference by means of the control module.

3. The method as claimed in claim 1, wherein a communication means is changed to a RF communication module having another communication mode in the step of avoiding the noise interference according to the detection result thereof by means of the control module, where two or more available frequency bands are included in the noise frequency band detected from the step of detecting the frequency band having the noise interference by means of the control module.

4. The method as claimed in claim 3, wherein the RF communication module having another communication mode is an IR optical communication module.

5. The method as claimed in claim 1, wherein it is changed to an interference-free frequency within the available frequency band of trying a communication in the step of avoiding the noise interference according to the detection result thereof by means of the control module, where the noise frequency band detected from the step of detecting the frequency band having the noise interference by means of the control module is narrower than a certain standard.

6. The method as claimed in claim 1, wherein it communicates at the same time through two or more frequencies within the available frequency band of trying a communication in the step of avoiding the noise interference according to the detection result thereof by means of the control module, where the noise frequency band detected from the step of detecting the frequency band having the noise interference by means of the control module is narrower than a certain standard.

7. The method as claimed in claim 1, wherein it retries a transmission of a communication signal several times within a predetermined time in the step of avoiding the noise interference according to the detection result thereof by means of the control module, where the noise interference is discontinuously detected in the step of detecting the frequency band having the noise interference by means of the control module.

8. The method as claimed in claim 7, wherein it stops the retry thereof when the response signal on the corresponding communication signal reaches from the communication unit for equipment and it repeats the retry at an interval of time if there is no response.

9. The method as claimed in claim 1, wherein it performs a step of detecting a noise signal intensity prior to the step of avoiding the noise interference according to the detection result thereof by means of the control module and amplifies an output by larger communication signal intensity than the noise signal intensity detected in the step of avoiding the noise interference according to the detection result thereof by means of the control module.

10. The method as claimed in claim 9, wherein the amplified power intensity information is included in the data packet when the output intensity of the communication is amplified to be communicated, so that it responds by the same output intensity when the communication unit for equipment responds.

11. The method as claimed in claim 1, wherein the step of trying the communication through the RF communication module by means of a control module in the communication unit for unmanned automatic transfer device is performed after the step of avoiding the noise interference according to the detection result thereof by means of the control module.
